(19) United States
(12) Patent Application Publication
(10) Pub. No.: US 2026/0290688 A1
(43) Pub. Date: Sep. 24, 2026

(54) MULTILAYER ELECTRONIC COMPONENT

(71) Applicant: SAMSUNG ELECTRO-MECHANICS CO., LTD., Suwon-si (KR)

(72) Inventors: Hwi Dae KIM, Suwon-si (KR); Se Hun PARK, Suwon-si (KR); Young Ghyu AHN, Suwon-si (KR)

(73) Assignee: SAMSUNG ELECTRO-MECHANICS CO., LTD., Suwon-si (KR)

(21) Appl. No.: 19/453,718

(22) Filed: Jan. 20, 2026

(30) Foreign Application Priority Data
Mar. 19, 2025 (KR) 10-2025-0035028

(51) Int. Cl. H01G 4/005; H01G 4/232; H01G 4/248; H01G 4/30

(52) U.S. Cl. CPC H01G 4/005; H01G 4/232; H01G 4/248; H01G 4/30

(57) ABSTRACT

A multilayer electronic component includes a body and first to fourth external electrodes spaced apart from each other on the body. The body may include a dielectric layer and first and second internal electrode layers alternately disposed in the thickness direction with the dielectric layer interposed therebetween. The body may include first and second surfaces opposing each other in the thickness direction, third and fourth surfaces connected to the first and second surfaces and opposing each other in a length direction, and fifth and sixth surfaces connected to the first to fourth surfaces and opposing each other in a width direction. The first internal electrode layer may include first to fourth internal electrodes connecting to the first to fourth external electrodes and spaced apart from each other. The second internal electrode layer may be a fifth internal electrode not connecting to the first to fourth external electrodes.

### CROSS REFERENCE TO RELATED APPLICATION(S)

This application claims benefit of priority to Korean Patent Application No. 10-2025-0035028 filed on Mar. 19, 2025 in the Korean Intellectual Property Office, the disclosure of which is incorporated herein by reference in its entirety.

### TECHNICAL FIELD

The present disclosure relates to a multilayer electronic component.

### BACKGROUND ART

A multilayer ceramic capacitor (MLCC), a multilayer electronic component, is a chip-type condenser, mounted on the printed circuit boards of various types of electronic products, such as image display devices including a liquid crystal display LCD and a plasma display panel PDP, computers, smartphones and mobile phones, and may be configured to charge electricity therein or discharge electricity therefrom.

Such multilayer ceramic capacitors may be used as a component in various electronic devices due to having a small size, ensuring high capacitance and easy mounting. As various electronic devices, such as computers and mobile devices, or the like, become smaller and have higher output, the demand for miniaturization and high capacitance of multilayer ceramic capacitors is increasing.

Additionally, in order to resolve noise in high-speed integrated circuits (ICs), a Land Side Capacitor (LSC) may be applied adjacent to the IC, and it is known that LSCs require low thickness and high-frequency characteristics. To reduce equivalent series inductance (ESL), it is important to minimize the number of magnetic flux linkages per unit current in a high-frequency region. To achieve this, various methods are being used, such as controlling the formation and structure in a direction minimizing a current loop or disposing the internal and external electrodes in one or more directions that may offset a magnetic field.

Meanwhile, while ESL characteristics are important, the demand for improved reliability for stable operation of MLCCs is also increasing, and in the case of LSCs, a design with a low thickness entails a decrease in dielectric capacitance, which requires compensation. In addition, the demand for a square form factor having substantially the same length and width when mounted on a substrate is also increasing. An optimal design therefor is required.

### DISCLOSURE OF THE INVENTION

### Technical Problem

One of the problems to be solved by the present disclosure is to provide a multilayer electronic component having improved high-frequency characteristics (Low ESL).

One of the problems to be solved by the present disclosure is to provide a multilayer electronic component having improved moisture resistance reliability.

One of the problems to be solved by the present disclosure is to provide a multilayer electronic component having improved step height

One of the problems to be solved by the present disclosure is to provide a multilayer electronic component having excellent operational reliability that may minimize current interruption even when cracks occur.

One of the problems to be solved by the present disclosure is to provide a multilayer electronic component having excellent capacitance characteristics.

One of the problems to be solved by the present disclosure is to provide a multilayer electronic component minimizing delamination of external electrodes.

However, the many problems to be solved by the present disclosure are not limited to the above and will be more easily understood in the process of describing specific embodiments of the present disclosure.

### Solution to Problem

A multilayer electronic component comprises: a body including a dielectric layer and first and second internal electrode layers alternately disposed in a thickness direction with the dielectric layer interposed therebetween, first and second surfaces opposing each other in the thickness direction, third and fourth surfaces connected to the first and second surfaces and opposing each other in a length direction, and fifth and sixth surfaces connected to the first to fourth surfaces and opposing each other in a width direction; and first to fourth external electrodes spaced apart from each other on the body, wherein the first internal electrode layer includes first to fourth internal electrodes connecting to the first to fourth external electrodes and spaced apart from each other, and wherein the second internal electrode layer comprises a fifth internal electrode not connecting to the first to fourth external electrodes.

### Advantageous Effects of Invention

One of many effects of the present disclosure is to improve high frequency characteristics (Low ESL) of multilayer electronic components.

One of many effects of the present disclosure is to improve a moisture resistance reliability of multilayer electronic components.

One of many effects of the present disclosure is to improve a step height of multilayer electronic components.

One of many effects of the present disclosure is to improve an operational reliability of multilayer electronic components.

One of many effects of the present disclosure is to improve capacitance characteristics of multilayer electronic components.

One of many effects of the present disclosure is to minimize external electrode delamination of multilayer electronic components.

However, the various advantageous effects of the present disclosure are not limited to the above and will be more easily understood in the process of explaining specific embodiments of the present disclosure.

### BRIEF DESCRIPTION OF DRAWINGS

FIG. 1 schematically illustrates a perspective view of a multilayer electronic component according to an embodiment of the present disclosure.

FIGS. 2A and 2B schematically illustrate plan views of first and second internal electrode layers and an external electrode.

FIG. 3 schematically illustrates a cross-sectional view taken along line I-I′ of FIG. 1.

FIGS. 4A and 4B schematically illustrate plan views of first and second internal electrode layers and external electrodes according to another embodiment of the present disclosure.

FIG. 5 schematically illustrates a cross-sectional view taken along line I-I′ of FIG. 1 according to another embodiment of the present disclosure.

FIGS. 6A and 6B are graphs illustrating the impedance and equivalent series resistance (ESR) measured for various test examples.

### DESCRIPTION OF REFERENCE CHARACTERS

Hereinafter, embodiments of the present disclosure will be described with reference to specific embodiments and the accompanying drawings. However, embodiments of the present disclosure may be modified to have various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawings, a Z-direction may be defined as a thickness direction or a first direction, an X-direction as a length direction or a second direction, and a Y-direction as a width direction or a third direction. Additionally, a stacking direction may be a thickness direction or a width direction.

### Multilayer Electronic Component

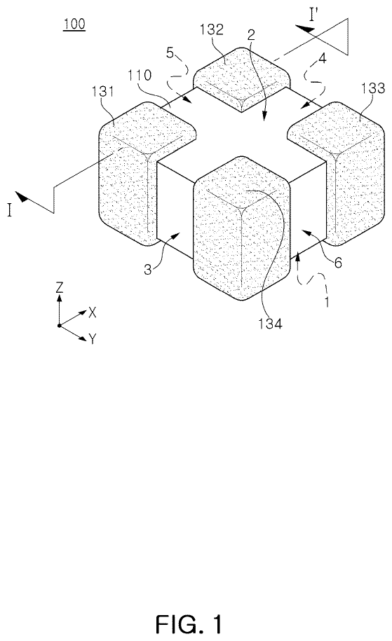

FIG. 1 schematically illustrates a perspective view of a multilayer electronic component according to an embodiment of the present disclosure.

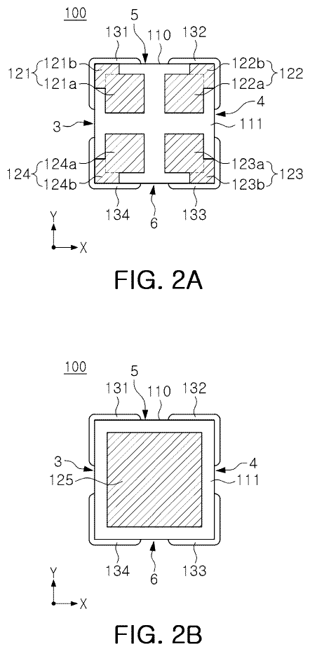

FIGS. 2A and 2B schematically illustrate plan views of first and second internal electrode layers and an external electrode.

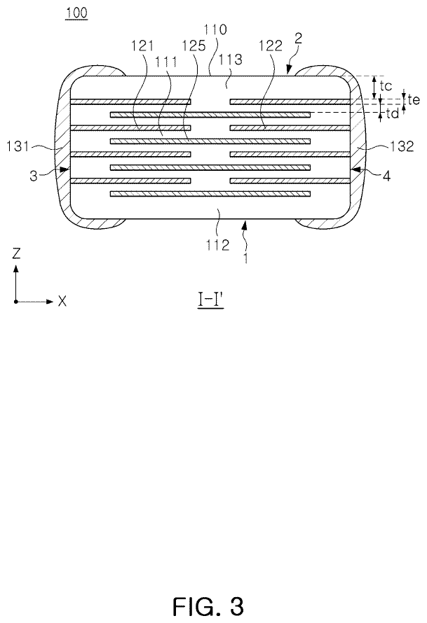

FIG. 3 schematically illustrates a cross-sectional view taken along line I-I′ of FIG. 1.

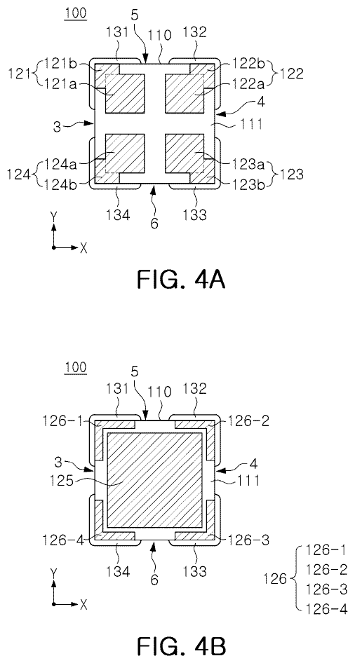

FIGS. 4A and 4B schematically illustrate plan views of first and second internal electrode layers and external electrodes according to another embodiment of the present disclosure.

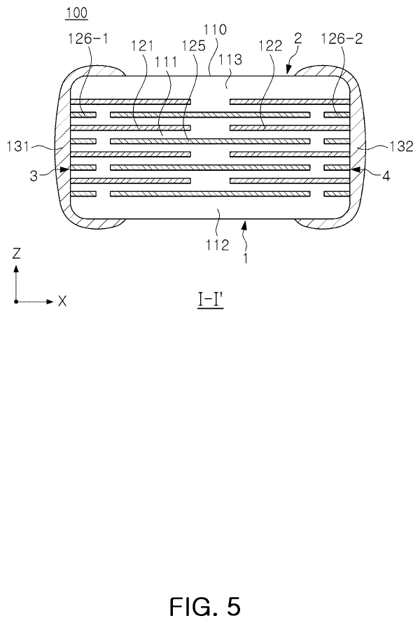

FIG. 5 schematically illustrates a cross-sectional view taken along line I-I′ of FIG. 1 according to another embodiment of the present invention.

Hereinafter, a multilayer electronic component according to an embodiment of the present disclosure will be described in detail with reference to FIGS. 1 to 5. However, as an example of a multilayer electronic component, a multilayer ceramic capacitor is described, but the present disclosure may also be applied to various electronic products using a dielectric composition, such as inductors, piezoelectric elements, varistors, or thermistors.

A multilayer electronic component 100 according to an embodiment of the present disclosure may comprise: a body 110 including a dielectric layer 111 and first and second internal electrode layers alternately disposed in a thickness direction with the dielectric layer 111 interposed therebetween; first and second surfaces 1 and 2 opposing each other in the thickness direction, third and fourth surfaces 3 and 4 connected to the first and second surfaces 1 and 2, and opposing each other in a length direction, and fifth and sixth surfaces 5 and 6 connected to the first to fourth surfaces 1, 2, 3 and 4, and opposing each other in a width direction; and first to fourth external electrodes 131, 132, 133 and 134 spaced apart from each other on the body 110, wherein the first internal electrode layer may include first to fourth internal electrodes 121, 122, 123 and 124 which are connected to the first to fourth external electrodes 131, 132, 133 and 134, and may be spaced apart from each other, wherein the second internal electrode layer may include a fifth internal electrode 125 that may be not connected to the first to fourth external electrodes 131, 132, 133 and 134.

The body 110 may have a dielectric layer 111 and an internal electrode layer alternately stacked.

More specifically, the body 110 may include a capacitance formation portion forming a capacitance, including a first internal electrode layer and a second internal electrode layer that are alternately disposed to oppose each other with a dielectric layer 111 interposed therebetween, the electrodes being disposed inside the body 110.

There is no particular limitation on the specific shape of the body 110, but as illustrated, the body 110 may have a hexahedral shape or a shape similar thereto. Due to shrinkage of ceramic particles included in the body 110 during a sintering process, the body 110 may not have a hexahedral shape with entirely straight lines but may have a substantially hexahedral shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

A plurality of dielectric layers 111 forming the body 110 are in a sintered state, such that boundaries between adjacent dielectric layers 111 may be integrated so as to be difficult to identify without using a scanning electron microscope (SEM).

The raw material forming the dielectric layer 111 is not limited as long as sufficient electrostatic capacitance can be obtained. In general, perovskite ABO₃-based materials may be used, for example, barium titanate-based materials, lead composite perovskite-based materials, or strontium titanate-based materials may be used. The barium titanate-based material may include BaTiO₃-based ceramic particles, and examples of the ceramic particles include BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1), in which calcium Ca, zirconium Zr, or the like are partially dissolved.

In addition, the raw material for forming the dielectric layer 111 may be particles such as barium titanate BaTiO₃, to which various ceramic additives, organic solvents, binders, dispersants, or the like, may be added according to the purpose of the present disclosure.

Meanwhile, in order to distinguish a dielectric layer from the dielectric layers included in cover portions 112 and 113 to be described later, the dielectric layer included in the capacitance formation portion may be defined as a first dielectric layer, and the dielectric layer included in the cover portions 112 and 113 may be defined as a second dielectric layer.

Furthermore, since the first and second dielectric layers may be formed using a dielectric material such as barium titanate BaTiO₃, they may include a dielectric microstructure after sintering. The dielectric microstructure may include a plurality of grains, grain boundaries disposed between adjacent grains, and triple points disposed at points where three or more grain boundaries meet.

However, in order to more easily implement miniaturization and high capacitance of the multilayer electronic component, the thickness td of the dielectric layer 111 may be 1.2 μm or less, 1.0 μm or less, 0.8 μm or less, or 0.6 μm or less, and in order to implement ultra-miniaturization and high dielectric characteristics, it may be 0.5 μm or less, or 0.4 μm or less.

Here, the thickness td of the dielectric layer 111 may mean the thickness td of the dielectric layer 111 disposed between the first and second internal electrode layers (e.g., between the first internal electrode 121 and the fifth internal electrode 125, or between the second internal electrode 122 and the fifth internal electrode 125).

In this case, the thickness td of the dielectric layer 111 may be a concept including the thickness td of any one of a plurality of dielectric layers 111 or may be a concept including the thickness td of each of all dielectric layers 111.

In addition, the thickness td of the dielectric layer 111 may mean the average thickness td of one dielectric layer 111, may mean an average thickness td of each of the plurality of dielectric layers 111, or may mean the average thickness td of the plurality of dielectric layers 111.

The average thickness td of the dielectric layer 111 may be measured by scanning an image of a cross-section in the length and thickness direction of the body 110 using a field emission scanning electron microscope (SEM) at 10,000× magnification. More specifically, the average thickness td of one dielectric layer 111 may mean an average value calculated by measuring the thickness of one dielectric layer 111 at 5 points equally spaced apart in the longitudinal direction in a scanned image. The 5 points equally spaced apart from each other may be designated in the capacitance formation portion. In addition, by extending this average value measurement to 3 dielectric layers 111 and calculating the average value, the average thickness td of the plurality of dielectric layers 111 may be further generalized.

The internal electrode layers may be alternately stacked with the dielectric layers 111.

The internal electrode layer may include the first internal electrode layer and a second internal electrode layer, and the first and second internal electrode layers may be disposed alternately with the dielectric layer 111 interposed therebetween constituting the body 110.

The first internal electrode layer may include first to fourth internal electrodes 121, 122, 123 and 124 that are connected to the first to fourth external electrodes 131, 132, 133 and 134, and spaced apart from each other.

The first to fourth internal electrodes 121, 122, 123 and 124 may each include first to fourth main portions 121a, 122a, 123a and 124a overlapping with the fifth internal electrode 125 in the thickness direction, and first to fourth lead portions 121b, 122b, 123b and 124b not overlapping with the fifth internal electrode 125 in the thickness direction.

More specifically, a first internal electrode 121 may include a first main portion 121a overlapping with the fifth internal electrode 125 in the thickness direction, and a first lead portion 121b not overlapping with the fifth internal electrode 125 in the thickness direction. The first internal electrode 121 may be connected to a first external electrode 131 through the first lead portion 121b. A second internal electrode 122 may include a second main portion 122a overlapping the fifth internal electrode 125 in the thickness direction, and a second lead portion 122b not overlapping the fifth internal electrode 125 in the thickness direction. The second internal electrode 122 may be connected to a second external electrode 132 through the second lead portion 122b.

A third internal electrode 123 may include a third main portion 123b overlapping with the fifth internal electrode 125 in the thickness direction, and a third lead portion 123b not overlapping with the fifth internal electrode 125 in the thickness direction. The third internal electrode 123 may be connected to a third external electrode 133 through the third lead portion 123b. A fourth internal electrode 124 may include a fourth main portion 124a overlapping the fifth internal electrode 125 in the thickness direction, and a fourth lead portion 124b not overlapping the fifth internal electrode 125 in the thickness direction. The fourth internal electrode 124 may be connected to a fourth external electrode 134 through the fourth lead portion 124b.

Here, the first to fourth main portions 121a, 122a, 123a and 124a may mean a region forming a capacitance, and the first to fourth lead portions 121b, 122b, 123b and 124b may mean a region not forming a capacitance.

Since the first to fourth internal electrodes 121, 122, 123 and 124 are connected to the first to fourth external electrodes 131, 132, 133 and 134 through the first to fourth lead portions 121b, 122b, 123b and 124b, respectively, a low ESR characteristic may be implemented.

The first to fourth main portions 121a, 122a, 123a and 124a may be spaced apart from the third to sixth surfaces 3, 4, 5 and 6.

In other words, the first main portion 121a may be spaced apart from the third to sixth surfaces 3, 4, 5 and 6, a second main portion 122a may be spaced apart from the third to sixth surfaces 3, 4, 5 and 6, the third main portion 123a may be spaced apart from the third to sixth surfaces 3, 4, 5 and 6, and the fourth main portion 124a may be spaced apart from the third to sixth surfaces 3, 4, 5 and 6.

The first lead portion 121b may be disposed to contact at least one of the third and fifth surfaces 3 and 5, the second lead portion 122b may be disposed to contact at least one of the fourth and fifth surfaces 4 and 5, the third lead portion 123b may be disposed to contact at least one of the fourth and sixth surfaces 4 and 6, and the fourth lead portion 124b may be disposed to contact at least one of the third and sixth surfaces 3 and 6.

In other words, the first internal electrode 121 may not be connected to the second to fourth external electrodes 132, 133 and 134, but may be connected to the first external electrode 131, the second internal electrode 122 may not be connected to the first, third, and fourth external electrodes 131, 133 and 134, but may be connected to the second external electrode 132, the third internal electrode 123 may not be connected to the first, second, and fourth external electrodes 131, 132 and 134, but may be connected to the third external electrode 133, and the fourth internal electrode 124 may not be connected to the first to third external electrodes 131, 132 and 133, but may be connected to the fourth external electrode 134.

The second internal electrode layer may include the fifth internal electrode 125 that is not connected to the first to fourth external electrodes 131, 132, 133 and 134.

The fifth internal electrode 125 may be spaced apart from the third to sixth surfaces 3, 4, 5 and 6, and may not be connected to the first to fourth external electrodes 131, 132, 133 and 134. For example, the fifth internal electrode 125 may correspond to a floating electrode, or the like, but is not particularly limited thereto.

Since the first and second internal electrode layers have this structure, even if a crack occurs in a portion of a region of the capacitance forming portion, other regions where no crack occurs may contribute to forming the capacitance, thereby ensuring the operational reliability of the multilayer electronic component 100.

Meanwhile, the second internal electrode layer may include a sixth internal electrode 126 that is spaced apart from the fifth internal electrode 125.

The sixth internal electrode 126 may contribute to prevent peeling by increasing a bonding area with the external electrodes 131, 132, 133 and 134, and improving a bonding strength of the external electrodes 131, 132, 133 and 134, and may contribute to prevent the step difference due to repeated lamination of the first and second internal electrode layers. In other words, the sixth internal electrode 126 may correspond to a dummy electrode, or the like, but is not particularly limited thereto.

The sixth internal electrode 126 may include a 6-1 internal electrode 126-1 connected to the first external electrode 131, a 6-2 internal electrode 126-2 connected to the second external electrode 132, a 6-3 internal electrode 126-3 connected to the third external electrode 133, and a 6-4 internal electrode 126-4 connected to the fourth external electrode 134.

The 6-1 to 6-4 internal electrodes 126-1, 126-2, 126-3 and 126-4 may overlap with the first to fourth lead portions 121b, 122b, 123b and 124b in the thickness direction, respectively, and may not contribute to forming a capacitance.

The 6-1 internal electrode 126-1 may be disposed to contact at least one of the third and fifth surfaces 3 and 5, the 6-2 internal electrode 126-2 may be disposed to contact at least one of the fourth and fifth surfaces 4 and 5, the 6-3 internal electrode 126-3 may be disposed to contact at least one of the fourth and sixth surfaces 4 and 6, and the 6-4 internal electrode 126-4 may be disposed to contact at least one of the third and sixth surfaces 3 and 6.

Meanwhile, the body 110 may be formed by alternately stacking a first ceramic green sheet printed with a paste for the first internal electrode layer, which may become the first to fourth internal electrodes 121, 122, 123 and 124, and a second ceramic green sheet printed with a paste for the second internal electrode layer, which will become the fifth internal electrode 125 or the sixth internal electrode 126, and then firing the stack. The printing method of a conductive paste for the first and second internal electrode layers may use a screen-printing method or a gravure printing method, but the present disclosure is not limited thereto.

The material forming the first to sixth internal electrodes 121, 122, 123, 124, 125 and 126 is not particularly limited, and a material having excellent electrical conductivity may be used. For example, the internal electrodes may include one or more of nickel (Ni), copper (Cu), palladium (Pd), silver (Ag), gold (Au), platinum (Pt), tin (Sn), tungsten (W), titanium (Ti), and alloys thereof.

Meanwhile, the thickness the of the internal electrode layer does not need to be particularly limited, and the description of the thickness the of the internal electrode layer below may mean the thickness the of each of the first to fourth internal electrodes 121, 122, 123 and 124, and the thickness the of each of the fifth and sixth internal electrodes 125 and 126. In other words, the thickness the of the internal electrode layer may mean the thickness the of each of the first and second internal electrode layers.

In order to achieve miniaturization and high capacitance of the multilayer electronic component 100, the thickness the of the internal electrode layer may be 1.2 μm or less, 1.0 μm or less, 0.8 μm or less, or 0.6 μm or less, and in order to achieve ultra-miniaturization and high dielectric characteristics, it may be 0.5 μm or less, or 0.4 μm or less.

In this case, the thickness the of the internal electrode layer may be a concept including the thickness the of at least one of a plurality of internal electrode layers or may be a concept including the thickness the of all internal electrode layers.

Additionally, the thickness the of the internal electrode layer may mean an average thickness the of one internal electrode layer or may mean an average thickness the of each of the plurality of internal electrode layers or may mean an average thickness the of the plurality of internal electrode layers.

The average thickness the of the internal electrode layer may be measured by scanning an image of a cross-section of the body 110 in the length and thickness direction with a scanning electron microscope (SEM) at 10,000× magnification. More specifically, the average thickness the of one internal electrode layer may be an average value calculated by measuring the thickness of one internal electrode layer at 5 points equally spaced apart in the longitudinal direction in the scanned image. In this case, it may be desirable to measure the thickness of the internal electrodes disposed in the internal electrode layers. The 5 points equally spaced apart may be designated in the capacitance formation portion. Furthermore, by extending this average value measurement to 3 internal electrode layers and measuring the average value, the average thickness the of the plurality of internal electrode layers may be further generalized.

Meanwhile, the body 110 may include cover portions 112 and 113 disposed on both end-surfaces of the capacitance formation portion in the thickness direction.

Specifically, the body 110 may include a first cover portion 112 disposed on one surface of the capacitance formation portion in the thickness direction and a second cover portion 113 disposed on the other surface of the capacitance formation portion in the thickness direction. More specifically, for example, the body 110 may include the first cover portion 112 disposed on a lower portion of the capacitance formation portion in the thickness direction and the second cover portion 113 disposed on an upper portion of the capacitance formation portion in the thickness direction.

The first cover portion 112 and the second cover portion 113 may be formed by disposing or stacking a single second dielectric layer or two or more second dielectric layers on the upper and lower surfaces of the capacitance formation portion in the thickness direction, respectively, and may prevent damage to the internal electrodes due to physical or chemical stress.

The first cover portion 112 and the second cover portion 113 may not include internal electrodes 121 and 122 and may include the same dielectric material as the first dielectric layer 111 of the capacitance formation portion. That is, the first cover portion 112 and the second cover portion 113 may include a dielectric material, for example, a barium titanate (BaTiO₃)-based dielectric material.

Meanwhile, the thickness tc of the cover portions 112 and 113 may not need to be particularly limited, and a description of the thickness tc of the cover portions 112 and 113 may mean the thickness tc of each of the first cover portion 112 and the second cover portion 113.

However, in order to easily implement miniaturization and high capacitance of the multilayer electronic component 100, the thickness tc of the cover portions 112 and 113 may be 100 μm or less or 50 μm or less, preferably 30 μm or less, and more preferably 20 μm or less in ultra-small products.

Here, the thickness tc of the cover portions 112 and 113 may mean the average thickness of the cover portions 112 and 113.

Additionally, the average thickness tc of the cover portions 112 and 113 may mean the average thickness tc of each of the first and second cover portions 112 and 113 or may mean the average thickness tc of the first and second cover portions 112 and 113.

The average thickness tc of the cover portions 112 and 113 may be measured by scanning an image of a cross-section of the body 110 in the length and thickness direction using a scanning electron microscope (SEM) at 10,000× magnification. More specifically, it may mean an average value calculated by measuring the thickness at 5 points equally spaced apart in the longitudinal direction in an image scanned of one cover portions 112 and 113.

In addition, the average thickness tc of the cover portions 112 and 113 measured by the above-described method may have a value substantially the same as the average thickness of the cover portions 112 and 113 in the cross-section of the body 110 in the width and thickness direction.

In an embodiment of the present disclosure, a structure in the multilayer electronic component 100 having four external electrodes 131, 132, 133 and 134 is described, but the number or shape of the external electrodes 131, 132, 133 and 134 may be changed depending on the shape of the internal electrode or other purposes.

The external electrodes 131, 132, 133 and 134 may be disposed on the body 110 and may be connected to the internal electrodes 121, 122, 123 and 124.

More specifically, the external electrodes 131, 132, 133 and 134 may include first to fourth external electrodes 131, 132, 133 and 134 that are spaced apart from each other on the body 110.

The first external electrode 131 may be disposed to contact at least one of the third and fifth surfaces 3 and 5, the second external electrode 132 may be disposed to contact at least one of the fourth and fifth surfaces 4 and 5, the third external electrode 133 may be disposed to contact at least one of the fourth and sixth surfaces 4 and 6, and the fourth external electrode 134 may be disposed to contact at least one of the third and sixth surfaces 3 and 6.

Additionally, the first to fourth external electrodes 131, 132, 133 and 134 may be disposed on the first and second surfaces 1 and 2.

As described above, the first to fourth external electrodes 131, 132, 133 and 134 may be in contact with the first to fourth lead portions 121b, 122b, 123b and 124b, respectively, and may be disposed to cover the first to fourth lead portions 121b, 122b, 123b and 124b, respectively.

As disposing the external electrodes 131, 132, 133 and 134 to cover the lead portions 121b, 122b, 123b and 124b, short-circuiting of the internal electrodes due to external moisture penetration may be prevented, and bonding strength with the body may be improved to prevent peeling from occurring.

Here, “disposed to cover” may mean that the first to fourth external electrodes 131, 132, 133 and 134 are disposed so that no portion of the first to fourth lead portions 121b, 122b, 123b and 124b coming into contact with at least one surface (e.g., the first to sixth surfaces 1, 2, 3, 4, 5, 6) of the body 110 is exposed to the external.

The first to fourth external electrodes 131, 132, 133 and 134 may be formed of any material having electrical conductivity, such as metal, and a specific material may be determined by consideration of electrical characteristics and structural stability, or the like, and furthermore, may have a multilayer structure.

For example, the first to fourth external electrodes 131, 132, 133 and 134 may include a first electrode layer disposed on the body 110 and a second electrode layer disposed on the first electrode layer.

Here, it may be desirable for the first and second electrode layers correspond to distinct layers. However, it is not particularly limited to this and may be distinguished according to the order of the manufacturing process, and the first and second electrode layers may not be distinguished from each other and may be observed as one layer.

In the present disclosure, the term “distinguished” may mean that two layers are distinguished due to physical differences, chemical differences, and/or simple optical differences, and is not particularly limited thereto, but the distinction between layers may be identified by the presence or absence of an “interface.” The term “interface” may mean a surface where two layers in contact with each other are distinguishable from each other and may mean a state where they can be distinguished by differences in components, such as through Energy-Dispersive X-ray Spectroscopy (EDS) analysis using equipment such as a scanning electron microscope (SEM).

The first electrode layer may be formed by transferring a sheet including a conductive metal onto the body 110, or may be formed by applying a conductive paste for an external electrode including a conductive metal to the body 110 and then performing sintering, or may be formed by dipping the body 110 into a conductive paste for an external electrode (e.g., external electrodes 131, 132, 133, 134) including a conductive metal, but is not particularly limited thereto.

As a more specific example of the first electrode layer, the first electrode layer may be a sintered electrode including a conductive metal and glass.

A material having excellent electrical conductivity may be used as the conductive metal included in the first electrode layer, for example, the conductive metal may include one or more selected from the group consisting of nickel (Ni), copper (Cu), palladium (Pd), silver (Ag), gold (Au), platinum (Pt), tin (Sn), tungsten (W), titanium (Ti) and alloys thereof, but is not particularly limited thereto.

Additionally, the glass included in the first electrode layer may contribute to prevent bonding with the body 110.

The second electrode layer may contribute to improve mounting characteristics and may be a plating layer formed on the first electrode layer by plating but is not particularly limited thereto.

The types of the second electrode layer are not particularly limited, and may include, for example, at least one of nickel (Ni), tin (Sn), silver (Ag), palladium (Pd), and alloys thereof.

The second electrode layer may be one layer or may be plurality of layers.

More specifically, for example, the second electrode layer may be a nickel (Ni) electrode layer or a tin (Sn) electrode layer, and may be formed of a nickel (Ni) electrode layer and a tin (Sn) electrode layer sequentially formed on the first electrode layer, or may be formed in a form of a tin (Sn) electrode layer, a nickel (Ni) electrode layer, and a tin (Sn) electrode layer sequentially formed. Additionally, the second electrode layer may include a plurality of nickel (Ni) electrode layers and/or a plurality of tin (Sn) electrode layers.

There is no need to specifically limit the size of the multilayer electronic component 100.

However, in order to simultaneously implement the effect of reducing the ESR and ESL in the high-frequency region and the effect of improving the moisture-resistant mechanical strength, it may be desirable to have a form factor where a longitudinal length and a widthwise length of the multilayer electronic component 100 are similar.

The effect according to the present disclosure may be significantly improved in the multilayer electronic component 100 having a shape where the longitudinal length and the widthwise length are substantially the same, and for example, the effect according to the present disclosure may be more significantly improved in a size of 0606 (length in the longitudinal direction×length in the widthwise direction: 0.6 mm×0.6 mm) or less. The longitudinal length can be measured, for example, in the second direction (i.e. the X-direction) and the widthwise length can be measured, for example, in the third direction (i.e. the Y-direction) but is not limited thereto.

In this case, the preferred thickness of the multilayer electronic component 100 to be used for LSC purposes may be 0.3 mm or less or 0.2 mm or less, and more preferably 0.1 mm or less.

Here, the longitudinal length and the widthwise length may mean a longitudinal average length and a widthwise average length, respectively, and the longitudinal length and the widthwise length being substantially the same does not mean that they are completely the same but may mean that they include an allowable error range.

More specifically, for example, it may mean that the difference between the longitudinal average length and the widthwise average length is 10% or less, and more preferably, 5% or less. When the length and width are substantially the same, the current loop area may be reduced, so that a multilayer electronic component 100 with low ESL can be more easily implemented.

Hereinafter, the present disclosure will be described in more detail through test examples, but this is only to help a specific understanding of the disclosure, and the scope of the present disclosure is not limited by the test examples.

### (Example Test)

[Table 1] below describes the dielectric characteristics measured for first to fourth test examples with different internal electrode layer structures in a multilayer electronic component having a square form-factor structure. Test examples 1 to 4 include first to fourth external electrodes.

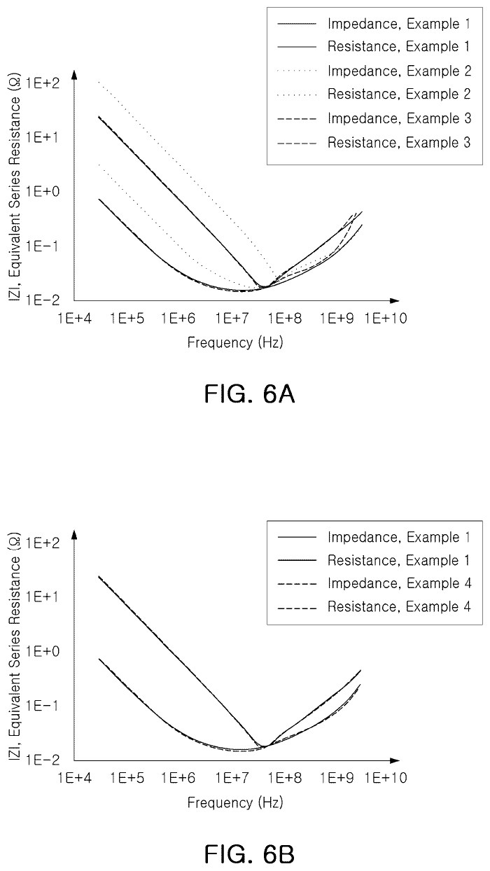

FIG. 6A is a graph illustrating an impedance (|Z|) and equivalent series resistance (Ω) values measured according to the frequency of Test Examples 1 to 4, and FIG. 6B is a graph illustrating the impedance (|Z|) and equivalent series resistance (Ω) values according to the frequency of Test Examples 1 and 4. Among the same type of lines illustrated in the graph, an upper line corresponds to the impedance (|Z|) value and a lower line corresponds to the equivalent series resistance (Ω) value.

Test Example 1 is a multilayer electronic component having a conventional square form-factor structure, in which first and second internal electrodes with lead portions extending in different diagonals are alternately stacked. Based on the cross-section in the length and width directions, the first external electrode is disposed at an upper left corner of the body, the second external electrode is disposed at an upper right corner of the body, the third external electrode is disposed at a lower right corner of the body, and the fourth external electrode is disposed at a lower left corner of the body, and may have the same structure as the first to fourth external electrodes 131, 132, 133, 134 of the present disclosure. The first internal electrode is connected to the first external electrode and the third external electrode through lead portions disposed at the upper left corner and the lower right corner, and the second internal electrode is connected to the second external electrode and the fourth external electrode through lead portions disposed at the upper right corner and the lower left corner. Barium titanate (BaTiO₃) may be used as the dielectric material of the dielectric layer.

Test Example 2 may have an internal electrode layer structure corresponding to an embodiment of the present disclosure. It is a structure where a first internal electrode layer including first to fourth internal electrodes (e.g. including the first to fourth internal electrodes 121, 122, 123, and 124) and a second internal electrode layer including a fifth internal electrode (floating electrode) (e.g. including the fifth internal electrode 125) are alternately stacked. The dielectric composition of the dielectric layer was manufactured in the same manner as in Test Example 1.

Test Example 3 may have an internal electrode layer structure corresponding to an embodiment of the present disclosure and may have the same internal electrode layer structure as Test Example 2. Barium titanate (BaTiO₃) may be used as the dielectric layer material, but the dielectric composition may be designed differently from that of Test Example 2 to improve the dielectric constant.

Test Example 4 may have an internal electrode layer structure corresponding to an embodiment of the present disclosure and may have the same internal electrode layer structure as Test Example 2. However, the number of layers may be increased by thinning the dielectric layer and internal electrodes. The dielectric composition of the dielectric layer may be manufactured in the same manner as in Test Example 1.

The longitudinal margin refers to a length by which an area contributing to the capacitance among the internal electrodes (e.g., along the main portions 121a, 122a, 123a, 124a) is spaced apart from a longitudinal surface of the body (e.g., symmetry along the body 110 from the third surface 3 to the fourth surface 4), a width margin refers to a length by which an area contributing to the capacitance among the internal electrodes is spaced apart from a width surface of the body (e.g. symmetry along the body 110 from the fifth surface 5 to the sixth surface 6), and a central margin refers to a distance by which the areas are spaced apart from each other in a central surface in the structures of Test Examples 2 to 4 having four internal electrode structures (e.g. first to fourth internal electrodes 121, 122, 123, and 124) in one internal electrode layer.

TABLE 1

| | Test | | Test | | Test | | Test | |
|---|---|---|---|---|---|---|---|---|
| Item | Example 1 | | Example 2 | | Example 3 | | Example 4 | |
| Permittivity | 4000 | | 4000 | | 16858.33 | | 4000 | |
| Body length | 0.58 | mm | 0.58 | mm | 0.58 | mm | 0.58 | mm |
| Body width | 0.58 | mm | 0.58 | mm | 0.58 | mm | 0.58 | mm |
| Body thickness | 0.08 | mm | 0.08 | mm | 0.08 | mm | 0.08 | mm |
| Number of layers | 25 | | 25 | | 25 | | 50 | |
| Dielectric layer thickness | 1.02 | μm | 1.02 | μm | 1.02 | μm | 0.5 | μm |
| (td) | | | | | | | | |
| Internal electrode layer | 1 | μm | 1 | μm | 1 | μm | 0.5 | μm |
| thickness (te) | | | | | | | | |
| Lengthwise margin | 35 | μm | 35 | μm | 35 | μm | 35 | μm |
| Widthwise margin | 35 | μm | 35 | μm | 35 | μm | 35 | μm |
| Central margin | 0 | μm | 30 | μm | 30 | μm | 30 | μm |
| Cover thickness | 15.26 | μm | 15.26 | μm | 15.26 | μm | 15.25 | μm |
| Overlap length | 510 | μm | 480 | μm | 480 | μm | 480 | μm |
| Overlap width | 510 | μm | 480 | μm | 480 | μm | 480 | μm |
| Dielectric capacitance (C) | 216.74592 | nF | 47.99909647 | nF | 202.296152 | nF | 199.9162368 | nF |

In the case of Test Example 2 having a floating electrode structure, the overlap area is reduced compared to Test Example 1, and four capacitance implementation units are connected in series per layer, so the total capacitance appears to be reduced, and in this case, it may be confirmed that the impedance and resistance values increase at frequencies below the Self-Resonant Frequency (SRF).

In the case of Test Examples 3 and 4, it may be confirmed that the dielectric and resistance characteristics are similar or almost the same as those of Test Example 1 even though a floating electrode structure is added. According to this, it may be seen that Test Examples 3 and 4 have an overlapping area similar to that of Test Example 2, but the ESR is reduced as the lead portion is drawn out in four places. Additionally, it may be seen that the dielectric capacitance is improved by using a material with a high dielectric constant (Test Example 3) or by increasing the number of layers and multilayers of the dielectric layer and internal electrodes (Test Example 4) due to the relatively low overlap area.

Although the embodiments or test examples of the present disclosure have been described in detail above, the present disclosure is not limited by the above-described embodiments and the accompanying drawings and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment and are not intended to limit the disclosure. In this case, singular expressions include plural expressions unless the context clearly indicates otherwise.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including a dielectric layer and first and second internal electrode layers alternately disposed in a thickness direction with the dielectric layer interposed therebetween, first and second surfaces opposing each other in the thickness direction, third and fourth surfaces connected to the first and second surfaces and opposing each other in a length direction, and fifth and sixth surfaces connected to the first to fourth surfaces and opposing each other in a width direction; and
first to fourth external electrodes spaced apart from each other on the body,
wherein the first internal electrode layer includes first to fourth internal electrodes connecting to the first to fourth external electrodes and spaced apart from each other, and
wherein the second internal electrode layer includes a fifth internal electrode not connecting to the first to fourth external electrodes.

2. The multilayer electronic component of claim 1, wherein the first to fourth internal electrodes each include first to fourth main portions overlapping with the fifth internal electrode in the thickness direction, and first to fourth lead portions not overlapping with the fifth internal electrode in the thickness direction.

3. The multilayer electronic component of claim 2, wherein the first internal electrode is connected to the first external electrode through the first lead portion, the second internal electrode is connected to the second external electrode through the second lead portion, the third internal electrode is connected to the third external electrode through the third lead portion, and the fourth internal electrode is connected to the fourth external electrode through the fourth lead portion.

4. The multilayer electronic component of claim 2, wherein the first lead portion is disposed to contact at least one of the third and fifth surfaces, the second lead portion is disposed to contact at least one of the fourth and fifth surfaces, the third lead portion is disposed to contact at least one of the fourth and sixth surfaces, and the fourth lead portion is disposed to contact at least one of the third and sixth surfaces.

5. The multilayer electronic component of claim 2, wherein the first to fourth main portions are spaced apart from the third to sixth surfaces.

6. The multilayer electronic component of claim 1, wherein the second internal electrode layer further includes a sixth internal electrode spaced apart from the fifth internal electrode,
wherein the sixth internal electrode includes a 6-1 internal electrode connected to the first external electrode, a 6-2 internal electrode connected to the second external electrode, a 6-3 internal electrode connected to the third external electrode, and a 6-4 internal electrode connected to the fourth external electrode.

7. The multilayer electronic component of claim 6,
wherein the first to fourth internal electrodes each include first to fourth main portions overlapping with the fifth internal electrode in the thickness direction, and first to fourth lead portions not overlapping with the fifth internal electrode in the thickness direction, and
wherein the 6-1 to 6-4 internal electrodes overlap the first to fourth lead portions in the thickness direction, respectively.

8. The multilayer electronic component of claim 6, wherein the 6-1 internal electrode is disposed to contact at least one of the third and fifth surfaces, the 6-2 internal electrode is disposed to contact at least one of the fourth and fifth surfaces, the 6-3 internal electrode is disposed to contact at least one of the fourth and sixth surfaces, and the 6-4 internal electrode is disposed to contact at least one of the third and sixth surfaces.

9. The multilayer electronic component of claim 1, wherein the first external electrode is disposed to contact at least one of the third and fifth surfaces, the second external electrode is disposed to contact at least one of the fourth and fifth surfaces, the third external electrode is disposed to contact at least one of the fourth and sixth surfaces, and the fourth external electrode is disposed to contact at least one of the third and sixth surfaces.

10. The multilayer electronic component of claim 1, wherein an average thickness of the dielectric layer is 0.5 μm or less.

11. The multilayer electronic component of claim 1, wherein an average thickness of the first and second internal electrode layers is each 0.5 μm or less.

12. The multilayer electronic component of claim 1, wherein an average thickness of the multilayer electronic component is 0.3 mm or less.

13. The multilayer electronic component of claim 1, wherein the body has a difference between a longitudinal average length and a widthwise average length of 10% or less compared to the longitudinal average length.
